(19) United States
(12) Patent Application Publication
(10) Pub. No.: US 2025/0304167 A1
(43) Pub. Date: Oct. 2, 2025

(54) TOWING ASSISTANCE APPARATUS

(71) Applicant: AISIN CORPORATION, Kariya (JP)

(72) Inventor: Daisuke SATO, Kariya-shi (JP)

(73) Assignee: AISIN CORPORATION, Kariya (JP)

(21) Appl. No.: 19/083,968

(22) Filed: Mar. 19, 2025

(30) Foreign Application Priority Data
Mar. 29, 2024 (JP) 2024-057635

(51) Int. Cl. B62D 15/02; B62D 6/00; B62D 13/06

(52) U.S. Cl. CPC B62D 15/027; B62D 6/002; B62D 13/06

(57) ABSTRACT

A towing assistance apparatus assists backward parking of a towing vehicle towing a towed vehicle. The towing assistance apparatus includes: a detector configured to detect a parking region having an entrance on a lateral side of the towing vehicle; and a calculator configured to generate a target path including a forward and backward path of the towing vehicle based on a default stop position and path set in advance The calculator calculates a first deviation amount in a front-rear direction of the towing vehicle between a target stop position determined based on the parking region and the default stop position, and a second deviation amount in the front-rear direction of the towing vehicle generated according to a parking angle when the towing vehicle is parked, and the forward path generated based on a sum of the first and second deviation amounts.

### CROSS REFERENCE TO RELATED APPLICATIONS

This application is based on and claims priority under 35 U.S.C. § 119 to Japanese Patent Application 2024-057635, filed on Mar. 29, 2024, the entire content of which is incorporated herein by reference.

### TECHNICAL FIELD

This disclosure relates to a towing assistance apparatus.

### BACKGROUND DISCUSSION

There is known an apparatus for performing towing assistance in a towing vehicle such as a tractor for towing a towed vehicle such as a trailer. For example, during towing assistance when the towed vehicle is towed backward, a towing assistance apparatus calculates a target path for the towed vehicle in advance, and controls the towing vehicle such that the towed vehicle moves on the calculated target path.

For example, in a technique disclosed in JP 2023-044216A (Reference 1), a plurality of backward path patterns are stored for a towed object, and in towing assistance, a plurality of backward trajectories for a towing vehicle are generated based on these backward path patterns and an appropriate backward trajectory is selected therefrom.

However, in the technique in Reference 1, it is necessary to generate a plurality of paths according to a positional relationship between the towing vehicle and a target stop position when the towing assistance is started, which increases calculation cost and increases difficulty in path generation depending on a parking angle.

A need thus exists for a towing assistance apparatus which is not susceptible to the drawback mentioned above.

### SUMMARY

A towing assistance apparatus according to an embodiment is a towing assistance apparatus that assists backward parking of a towing vehicle towing a towed vehicle, the towing assistance apparatus including: a detection unit configured to detect a parking region having an entrance on a lateral side of the towing vehicle; and a computation unit configured to generate a target path including a forward path and a backward path of the towing vehicle based on a default stop position and a default path that are set in advance, in which the computation unit calculates a first deviation amount in a front-rear direction of the towing vehicle, which is a deviation amount between a target stop position determined based on the parking region and the default stop position, and a second deviation amount in the front-rear direction of the towing vehicle, which is generated according to a parking angle when the towing vehicle is parked in the parking region, and generates the forward path based on a total value of the first and second deviation amounts.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a side view showing a tractor and a trailer according to an embodiment;

FIG. 2 is a top view showing the tractor and the trailer according to the embodiment;

FIG. 3 shows an example of a configuration of a towing assistance system provided in the tractor according to the embodiment;

FIG. 4 is a block diagram showing an example of a functional configuration of a towing assistance apparatus according to the embodiment;

FIG. 5 shows an example of an operation in which the towing assistance apparatus according to the embodiment generates a forward path in a target path;

FIG. 6 shows the example of the operation in which the towing assistance apparatus according to the embodiment generates the forward path in the target path;

FIG. 7 shows the example of the operation in which the towing assistance apparatus according to the embodiment generates the forward path in the target path;

FIG. 8 shows the example of the operation in which the towing assistance apparatus according to the embodiment generates the forward path in the target path;

FIG. 9 shows the example of the operation in which the towing assistance apparatus according to the embodiment generates the forward path in the target path;

FIG. 10 shows an example of an operation in backward parking assistance of the towing assistance apparatus according to the embodiment;

FIG. 11 shows the example of the operation in the backward parking assistance of the towing assistance apparatus according to the embodiment;

FIG. 12 is a flowchart showing an example of a procedure for generating a target path for backward parking by the towing assistance apparatus according to the embodiment;

FIG. 13 shows an example of an operation in which a towing assistance apparatus according to a modification of the embodiment generates a forward path in a target path;

FIG. 14 shows the example of the operation in which the towing assistance apparatus according to the modification of the embodiment generates the forward path in the target path; and

FIG. 15 is a flowchart showing an example of a procedure for generating a target path for backward parking by the towing assistance apparatus according to the modification of the embodiment.

### DETAILED DESCRIPTION

Hereinafter, an embodiment of a towing assistance apparatus disclosed here will be described in detail with reference to the accompanying drawings.

### Configuration Examples of Tractor and Trailer

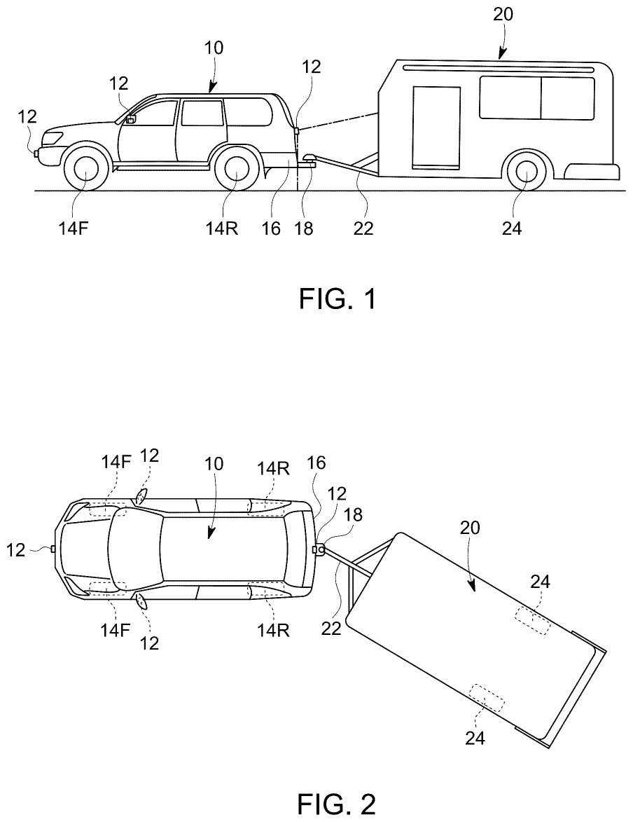

FIG. 1 is a side view showing a tractor 10 and a trailer 20 according to the embodiment. FIG. 2 is a top view showing the tractor 10 and the trailer 20 according to the embodiment. In FIGS. 1 and 2, the tractor 10 is used as a reference, a left direction on the page is defined as the front (forward traveling direction), and a right direction on the page is defined as the rear (backward traveling direction). The tractor 10 is an example of a towing vehicle, and the trailer 20 is an example of a towed vehicle towed by the towing vehicle such as the tractor 10.

The tractor 10 may be, for example, a vehicle such as an internal combustion engine automobile using an internal combustion engine (engine) as a drive source, a vehicle such as an electric automobile or a fuel cell automobile using an electric motor (motor) as a drive source, or a vehicle such as a hybrid automobile using both of the internal combustion engine and the electric motor as a drive source. Therefore, the tractor 10 can be equipped with various transmission apparatuses, and can also be equipped with various apparatuses, systems, and components necessary for driving the internal combustion engine or the electric motor.

The tractor 10 may also be a sport utility vehicle (SUV) as shown in FIG. 1, a so-called “pickup truck” with a cargo bed provided on a rear side of the vehicle, or a general passenger vehicle.

The tractor 10 includes, for example, four wheels 14 including a pair of front wheels 14F and a pair of rear wheels 14R. The tractor 10 in the embodiment is, for example, a rear-wheel drive vehicle driven by the rear wheels 14R. A method, a number, a layout, and the like related to driving of the wheels 14 of the tractor 10 can be set in various manners.

Imaging units 12 are provided at a front end, a rear end, and left and right side mirrors of the tractor 10. Each imaging unit 12 is, for example, a digital camera including an imaging element such as a charge coupled device (CCD) or a CMOS image sensor (CIS), captures an image of a periphery of the tractor 10 at predetermined frame rate, and outputs the captured image as image data.

The imaging unit 12 provided at the rear end of the tractor 10 sequentially captures images of a region including a coupling member 22 that couples the tractor 10 and the trailer 20, and at least a front end of the trailer 20, which is a range indicated by, for example, dash-double-dot lines in FIG. 1. An image captured with the imaging unit 12 can be used to detect a coupling angle representing a tilt of the trailer 20 in a left-right direction relative to the tractor 10. The coupling angle is also referred to as a hitch angle to be described later.

The imaging unit 12 provided at the front end of the tractor 10 sequentially captures images of a region in front of the tractor 10 and generates a captured image for recognizing a situation in front of the tractor 10. The imaging units 12 provided at the left and right side mirrors of the tractor 10 sequentially capture images of regions on lateral sides of the tractor 10 and generate captured images for recognizing a situation on the lateral sides of the tractor 10.

By executing various types of image processing including viewpoint modification, compositing, or the like on the captured images obtained by the plurality of imaging units 12 as described above, for example, an image having a wider viewing angle than a captured image obtained only by the single imaging unit 12 may be generated or a virtual overhead view image of the tractor 10 viewed from above may be generated as a peripheral image representing a situation around the tractor 10.

A number, a layout, and the like of the imaging units 12 provided at the tractor 10 can be set in various manners.

A hitch 18 that is a towing apparatus for towing the trailer 20 protrudes from a lower portion of a central portion of a rear bumper 16 of the tractor 10 in a vehicle width direction, for example. The hitch 18 is fixed to, for example, a frame of the tractor 10. The hitch 18 includes, as an example, a hitch ball 19 having a spherical tip portion erected in a vertical direction (vehicle up-down direction), and a coupler provided at a tip end of the coupling member 22 fixed to the trailer 20 covers the hitch ball 19. As a result, the tractor 10 and the trailer 20 are coupled to each other, and the trailer 20 is rotatable in the vehicle width direction relative to the tractor 10. That is, the hitch ball 19 transmits movement in front-rear and left-right directions to the trailer 20 via the hitch 18, and receives power for acceleration or deceleration.

The trailer 20 may be, for example, as shown in FIG. 1, a box-type trailer including at least one of a passenger space, a living section, and a storage space, or may be a flatbed type trailer on which cargo such as a container or a boat is placed. The trailer 20 shown in FIG. 1 includes a pair of wheels 24, as an example. The trailer 20 in the embodiment is assumed to be a driven vehicle including driven wheels that include no drive wheel nor steered wheel.

### Configuration Example of Towing Assistance System

The tractor 10 in the embodiment is equipped with, for example, a towing assistance system 100. The towing assistance system 100 assists driving of the tractor 10 towing the trailer 20.

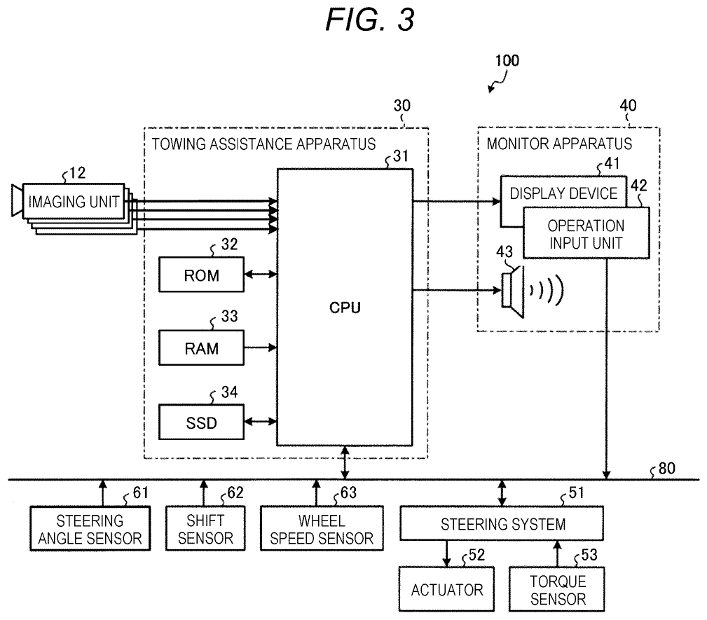

FIG. 3 shows an example of a configuration of the towing assistance system 100 provided in the tractor 10 according to the embodiment. As shown in FIG. 3, the towing assistance system 100 includes a towing assistance apparatus 30, a monitor apparatus 40, a steering system 51, an actuator 52, a torque sensor 53, a steering angle sensor 61, a shift sensor 62, a wheel speed sensor 63, and the imaging units 12.

In the towing assistance system 100, the towing assistance apparatus 30, the monitor apparatus 40, the steering system 51, the steering angle sensor 61, the shift sensor 62, and the wheel speed sensor 63 are electrically connected via an in-vehicle network 80 such as an electric communication line. The in-vehicle network 80 is implemented as, for example, a controller area network (CAN).

The towing assistance apparatus 30 is, for example, an electronic control unit (ECU), and is implemented as a computer including a central processing unit (CPU) 31, a read-only memory (ROM) 32, a random access memory (RAM) 33, and a solid-state drive (SSD) 34.

The CPU 31 can read a program installed and stored in a non-volatile storage apparatus such as the ROM 32 and perform computational processing according to the program. The RAM 33 temporarily stores various types of data used in the computation of the CPU 31. The SSD 34 is a rewritable non-volatile storage unit, and can store data even when the towing assistance apparatus 30 is powered off.

The CPU 31, the ROM 32, the RAM 33, and the like may be integrated in the same package. The towing assistance apparatus 30 may be implemented using another logical operation processor such as a digital signal processor (DSP), or a logic circuit instead of the CPU 31. In addition, a hard disk drive (HDD) may be provided instead of the SSD 34, and the SSD 34 or the HDD may be provided separately from the towing assistance apparatus 30.

The towing assistance apparatus 30 can control the steering system 51 and the like by transmitting a control signal through the in-vehicle network 80. The towing assistance apparatus 30 can receive detection results from the torque sensor 53, the steering angle sensor 61, the shift sensor 62, the wheel speed sensor 63, and the like via the in-vehicle network 80. The CPU 31 provided in the towing assistance apparatus 30 can receive an operation signal or the like from an operation input unit 42 or the like provided in the monitor apparatus 40, and can output a control signal or the like to a display device 41, an audio output device 43, or the like. The CPU 31 also receives the images captured by the plurality of imaging units 12.

The monitor apparatus 40 includes the display device 41, the operation input unit 42, and the audio output device 43, and is disposed at a central portion of a dashboard in the vehicle width direction (left-right direction).

The display device 41 is, for example, a liquid crystal display (LCD) or an organic electroluminescent display (OELD). The display device 41 can display the images captured by the imaging units 12, for example, when the trailer 20 is pushed back by the tractor 10 that travels backward and is towed backward under control of the towing assistance apparatus 30.

The display device 41 is covered with the operation input unit 42 such as a transparent touch panel. A driver of the tractor 10 can visually recognize an image displayed on a screen of the display device 41 via the operation input unit 42. The driver can issue various instructions to the towing assistance apparatus 30 by touching, pressing, or moving the operation input unit 42 with a finger or the like at a position corresponding to the image displayed on the screen of the display device 41.

As an example, the driver can instruct the towing assistance apparatus 30 to start towing assistance by operating the operation input unit 42. At this time, the driver may be capable of selecting, for example, a backward parking assistance mode or a forward parking assistance mode.

The backward parking assistance mode is selected when the tractor 10 and the trailer 20 are to be parked while the trailer 20 is towed backward by the tractor 10. The forward parking assistance mode is selected when the tractor 10 and the trailer 20 are to be parked while the trailer 20 is towed forward by the tractor 10. The towing assistance apparatus 30 performs towing assistance according to the selected mode.

The audio output device 43 is, as an example, a speaker.

The monitor apparatus 40 may also be used as a navigation system, an audio system, or the like, or may be provided separately from such systems.

The steering system 51 is, for example, an electric power steering system or a steer-by-wire (SBW) system, and includes the actuator 52 and the torque sensor 53.

The steering system 51 causes the actuator 52 to add torque, that is, assist torque, to a steering unit such as a steering wheel to supplement a steering force, or causes the actuator 52 to steer the wheels 14. In the tractor 10 in the embodiment, the front wheels 14F are steerable wheels. The actuator 52 may steer one wheel 14 or a plurality of wheels 14.

The steering system 51 is electrically controlled by the towing assistance apparatus 30 or the like, or operates the actuator 52 according to an operation performed by the driver on the steering unit such as the steering wheel. The torque sensor 53 detects, for example, torque applied to the steering unit by the driver.

The steering angle sensor 61 is, for example, an angle sensor that detects a steering amount of the steering unit such as the steering wheel. The steering amount of the steering unit is a steering angle of the tractor 10. The steering angle sensor 61 is implemented using, for example, a Hall element, and detects a rotation angle of a rotating portion provided in the steering unit. The towing assistance apparatus 30 acquires a steering amount of the steering unit by the driver, a steering amount of the wheels 14 during automated steering, and the like from the steering angle sensor 61, and performs various types of control.

The shift sensor 62 is, for example, a sensor that detects a position of a movable portion of a shift operation unit such as a shift lever. The shift sensor 62 can detect a position of a lever, an arm, a button, or the like as the movable portion. The shift sensor 62 may include a displacement sensor or may be implemented as a switch.

The wheel speed sensor 63 is a sensor that detects an amount of rotation of the wheels 14 and a rotation speed per unit time. The wheel speed sensor 63 is disposed on each wheel 14, and outputs the number of wheel speed pulses indicating a rotation speed detected at each wheel 14 as a sensor value. The wheel speed sensor 63 may include, for example, a Hall element. The towing assistance apparatus 30 calculates a movement amount of the tractor 10 based on the sensor value acquired from the wheel speed sensor 63, and performs various types of control.

Configurations, arrangements, electrical connection forms, and the like of the various sensors and actuators described above are merely examples, and can be set in various manners.

### Configuration Example of Towing Assistance Apparatus

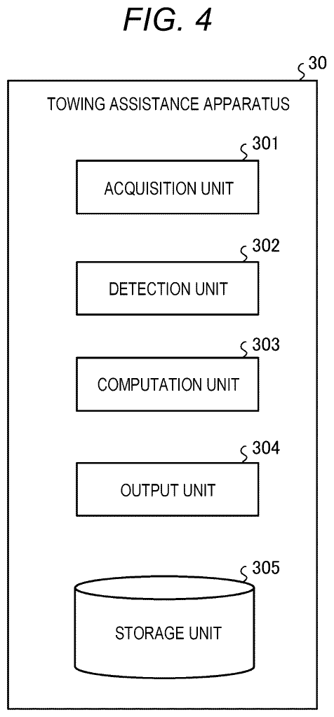

Next, an example of a functional configuration of the towing assistance apparatus 30 in the embodiment will be described with reference to FIG. 4. FIG. 4 is a block diagram showing the example of the functional configuration of the towing assistance apparatus 30 according to the embodiment.

As shown in FIG. 4, the towing assistance apparatus 30 includes an acquisition unit 301, a detection unit 302, a computation unit 303, an output unit 304, and a storage unit 305 as functional units. These functional units of the towing assistance apparatus 30 are implemented by the CPU 31 by loading a program stored in the ROM 32 or the like into the RAM and executing the program.

The program executed by the CPU 31 may be provided by being recorded on a computer-readable storage medium such as a CD-ROM, a flexible disk (FD), a CD-R, a digital versatile disk (DVD), or a universal serial bus (USB) as a file in an installable or executable format, or may be provided or distributed via a network such as the Internet. Various programs may be provided by being embedded in a non-volatile storage medium such as a ROM in advance.

However, what is disclosed here is not limited to the above-described embodiment, and at least a part of the above-described functional units may be implemented using a dedicated hardware circuit.

Hereinafter, an example will be described in which the driver selects the backward parking assistance mode or the like and the towing assistance apparatus 30 assists backward parking of the tractor 10 that tows the trailer 20.

The acquisition unit 301 acquires a captured image captured by the plurality of imaging units 12 described above as image data.

The detection unit 302 detects a parking region around the tractor 10 based on the captured image acquired by the acquisition unit 301. The parking region is detected by, for example, recognizing, from the captured image, a white line, a border line, or a wheel stop attached to the parking region, or a wall surrounding the parking region.

When backward parking assistance is started, the driver positions the tractor 10 alongside an entrance of the parking region, for example. Therefore, the detection unit 302 can detect the parking region from a captured image of the imaging unit 12 provided on the side mirror on the parking region side among the left and right side mirrors.

The computation unit 303 calculates a target path for causing the tractor 10 to travel to the parking region based on a positional relationship between the tractor 10 and the parking region detected by the detection unit 302.

As described above, in a case where the driver instructs the start of the backward parking assistance in a state where the tractor 10 is positioned alongside of the entrance of the parking region, the computation unit 303 generates the target path including a forward path for moving the tractor 10 forward from a backward parking start position, a turning position for changing the tractor 10 from forward movement to backward movement, and a backward path for moving the tractor 10 backward from the turning position to a target parking position in the parking region.

The output unit 304 transmits a signal for controlling the tractor 10 to the tractor 10 such that the tractor 10 travels along the target path.

The storage unit 305 stores various parameters, programs, and the like necessary for functions of the towing assistance apparatus 30.

### Operation Example of Towing Assistance Apparatus

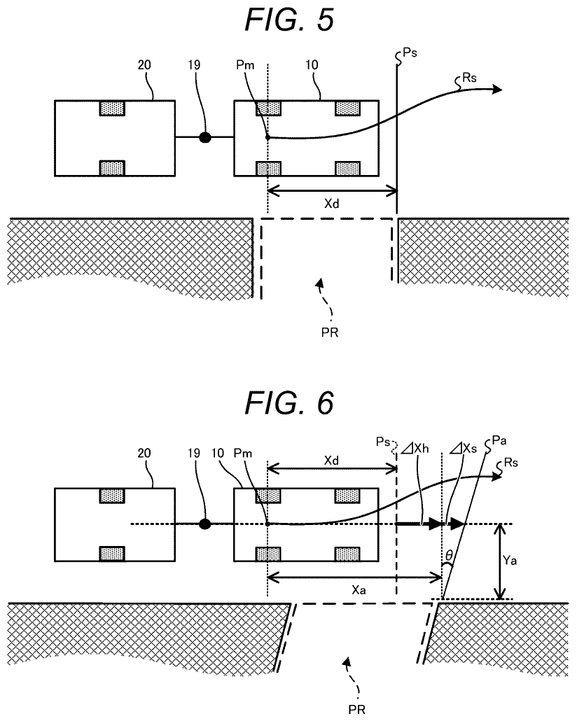

Next, an operation example of the towing assistance apparatus 30 in the embodiment will be described with reference to FIGS. 5 to 11.

FIGS. 5 to 9 show an example of an operation in which the towing assistance apparatus 30 according to the embodiment generates a forward path Ra in the target path. In the example in FIGS. 5 to 9, as described above, it is assumed that the backward parking assistance is started from a position where the tractor 10 is positioned alongside an entrance of a parking region PR.

FIG. 5 shows an example of a default stop position Ps and a default path Rs set in advance in the towing assistance apparatus 30.

As shown in FIG. 5, the default stop position Ps is set in front of the tractor 10 at a distance Xd from a tractor position Pm which is, for example, a center point of the pair of rear wheels 14R that are drive wheels of the tractor 10, that is, a midpoint of an axle of the rear wheels 14R.

The default stop position Ps is set on an assumption that the default stop position Ps is a position of a side portion in front of the tractor 10 among two side portions of the parking region PR in a width direction. That is, as in the example shown in FIG. 5, when the parking region PR is on a right side of the tractor 10, the default stop position Ps corresponds to a position of a right side portion of the parking region PR from the parking region PR side toward the entrance.

At this time, it is assumed that the parking region PR extends in a depth direction perpendicular to a side portion of the tractor 10. That is, it is assumed that the parking region PR is located such that the depth direction is perpendicular to a center line of the tractor 10 in a front-rear direction.

The default path Rs is set in advance with reference to the default stop position Ps, and is a path for moving the tractor 10 forward from the tractor position Pm to a predetermined front position of the tractor 10 at a start position of the backward parking assistance. The default path Rs is set such that the vehicle can be appropriately parked in the parking region PR based on the default stop position Ps to draw an S-shape from the tractor position Pm to the front position, for example.

FIG. 6 shows an example of deviation amounts ΔXh and AXs of the parking region PR actually detected by the towing assistance apparatus 30 relative to the default stop position Ps.

As shown in FIG. 6, when the detection unit 302 detects the parking region PR after the backward parking assistance is started, the computation unit 303 of the towing assistance apparatus 30 calculates the deviation amounts ΔXh and AXs from the default stop position Ps with the position of the side portion in front of the tractor 10 among the two side portions of the parking region PR in the width direction serving as a target stop position Pa.

The deviation amount ΔXh from the default stop position Ps is a deviation amount of the target stop position Pa from the default stop position Ps in a forward direction of the tractor 10. That is, as shown in the following equation (1), the deviation amount ΔXh is a value obtained by subtracting the distance Xd from a distance Xa from the tractor position Pm to the target stop position Pa.

$$Δ Xh = Xa - Xd \qquad ( 1 )$$

The deviation amount ΔXs from the default stop position Ps is a deviation amount caused by inclination of the target stop position Pa relative to the default stop position Ps. That is, the deviation amount ΔXs is a deviation amount from the default stop position Ps in the forward direction of the tractor 10 at a position where a virtual line extending from the side portion of the parking region PR set as the target stop position Pa intersects the center line of the tractor 10 in the front-rear direction. Therefore, the deviation amount ΔXs can be expressed by the following equation (2).

$$Δ Xs = Ya \cdot tan θ \qquad ( 2 )$$

A parking angle θ is an angle formed by a virtual line extending from the default stop position Ps in parallel with a width of the tractor 10 in the left-right direction and the virtual line extending from the side portion of the parking region PR set as the target stop position Pa. A distance Ya is a distance from a point where the virtual line extending from the default stop position Ps intersects the virtual line extending from the side portion of the parking region PR to the center line of the tractor 10 in the front-rear direction.

Setting of the default stop position Ps and the default path Rs described above is stored in, for example, the storage unit 305 of the towing assistance apparatus 30, and the computation unit 303 reads the setting from the storage unit 305 to calculate the deviation amounts ΔXh and ΔXs based on the above equations (1) and (2).

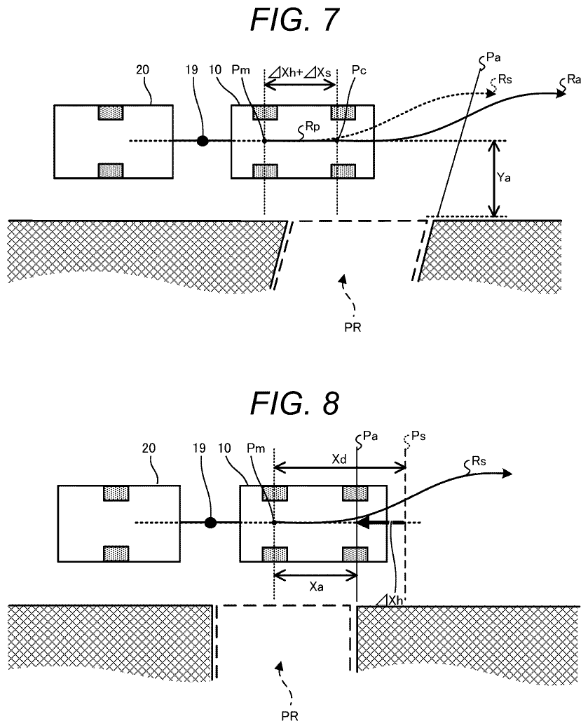

FIG. 7 shows an example of a preliminary path Rp and a forward path Ra generated by the towing assistance apparatus 30 based on the deviation amounts ΔXh and ΔXs relative to the default stop position Ps.

As shown in FIG. 7, the computation unit 303 of the towing assistance apparatus 30 generates the forward path Ra on which the tractor 10 is moved to a position shifted forward from the tractor position Pm by the deviation amounts ΔXh and ΔXs. In addition, the computation unit 303 adds, to the forward path Ra, the preliminary path Rp for moving the tractor 10 forward from the tractor position Pm to a start point Pc of the forward path Ra.

However, when a total value of the deviation amounts ΔXh and ΔXs is a negative value, the computation unit 303 generates the forward path Ra without shifting the start point Pc and without adding the preliminary path Rp. That is, in this case, the default path Rs becomes the forward path Ra directly.

Therefore, a distance of the preliminary path Rp from the tractor position Pm to the start point Pc of the forward path Ra can be expressed by the following equation (3) using a max function.

$$Distance of preliminary path Rp = max ( 0 , Δ Xh + Δ Xs ) \qquad ( 3 )$$

The max function in the above equation (3) means that a larger value between 0 and the total value (ΔXh+ΔXs) of the deviation amounts is set as a deviation amount of the start point Pc of the forward path Ra. The deviation amount of the start point Pc of the forward path Ra based on equation (3) also corresponds to the distance of the preliminary path Rp.

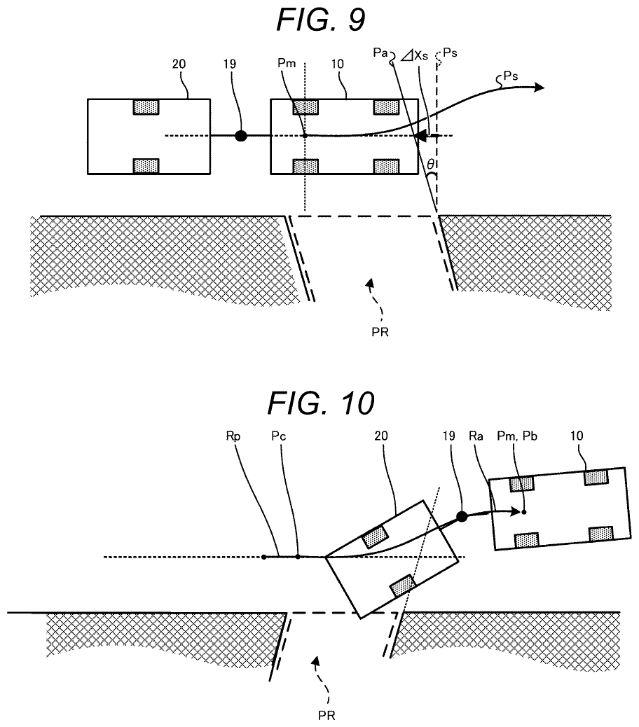

FIGS. 8 and 9 show examples in which the total value (ΔXh+ΔXs) of the deviation amounts from the default stop position Ps is a negative value.

As shown in FIG. 8, when the start of the backward parking assistance is instructed at a position where the tractor 10 moves excessively forward relative to the parking region PR, the target stop position Pa is a position on the near side of the tractor 10 relative to the default stop position Ps, and thus the deviation amount ΔXh is a negative value. In the example in FIG. 8, since the depth direction of the parking region PR extends perpendicular to the side portion of the tractor 10 and the parking angle θ is 0, the deviation amount ΔXs due to the parking angle θ is also 0.

As shown in FIG. 9, as another example of the case where the tractor 10 moves excessively forward relative to the parking region PR, a case where the parking angle θ is inclined to the near side of the tractor 10 is also conceivable. In this case, the deviation amount ΔXs is a negative value. In the example in FIG. 9, the default stop position Ps with reference to the entrance of the parking region PR coincides with the target stop position Pa, and the deviation amount ΔXh is zero.

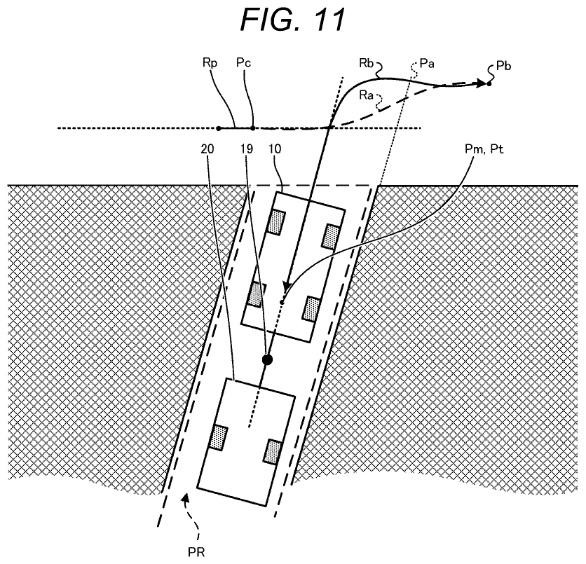

FIGS. 10 and 11 show an example of an operation in the backward parking assistance of the towing assistance apparatus 30 according to the embodiment. FIGS. 10 and 11 show an example in which the towing assistance apparatus 30 controls the tractor 10 to travel following the target path including the forward path Ra generated by the operation in FIGS. 5 to 7 described above.

When traveling control of the tractor 10 is started, the towing assistance apparatus 30 generates the entire target path including the forward path Ra and reaching the target parking position.

As shown in FIG. 10, the output unit 304 of the towing assistance apparatus 30 outputs a signal for controlling the traveling of the tractor 10 to the tractor 10, and causes the tractor 10 to travel along the forward path Ra in the target path.

As shown in FIG. 11, the output unit 304 continues to output the control signal of the tractor 10, changes the traveling of the tractor 10 to backward movement from a turning position Pb in the target path, causes the tractor 10 to travel along a backward path Rb in the target path, and stops the tractor 10 at a position where the tractor position Pm coincides with a target parking position Pt.

As described above, the tractor 10 and the trailer 20 are parked in the parking region PR, and the backward parking assistance operation performed by the towing assistance apparatus 30 is ended.

### Processing Example of Towing Assistance Apparatus

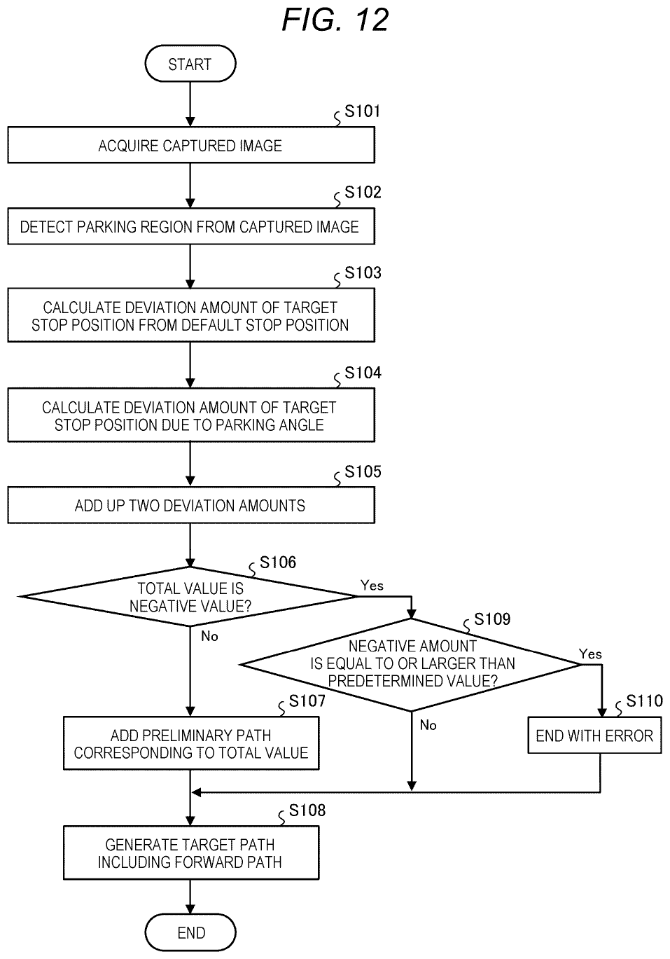

Next, a processing example of the towing assistance apparatus 30 according to the embodiment will be described with reference to FIG. 12. FIG. 12 is a flowchart showing an example of a procedure for generating a target path for backward parking by the towing assistance apparatus 30 according to the embodiment.

As shown in FIG. 12, the acquisition unit 301 of the towing assistance apparatus 30 acquires captured images from the plurality of imaging units 12 provided in the tractor 10 (step S101). The detection unit 302 detects the parking region PR around the tractor 10 based on these captured images (step S102).

The computation unit 303 reads the setting of the default stop position Ps described above from the storage unit 305, and calculates the deviation amount ΔXh from the target stop position Pa specified from the detected parking region PR in the front-rear direction of the tractor 10 using equation (1) described above (step S103). The computation unit 303 calculates the deviation amount ΔXs from the default stop position Ps caused by the parking angle θ of the target stop position Pa using equation (2) described above (step S104). Further, the computation unit 303 calculates the total value of the deviation amounts ΔXh and ΔXs (step S105).

The computation unit 303 determines whether the total amount of the deviation amounts ΔXh and ΔXs is a negative value (step S106).

If the total amount of the deviation amounts ΔXh and ΔXs is a positive value (step S106: No), the computation unit 303 generates the preliminary path Rp having a distance corresponding to the total value of the deviation amounts ΔXh and ΔXs (step S107).

If the total value of the deviation amounts ΔXh and ΔXs is a negative value (step S106: Yes), the computation unit 303 determines whether the negative amount of the total value of the deviation amounts ΔXh and ΔXs is equal to or larger than a predetermined value (step S109).

When the negative amount of the deviation amounts ΔXh and ΔXs is less than the predetermined value (step S109: No), the computation unit 303 does not disable the preliminary path Rp based on the total value of the deviation amounts ΔXh and ΔXs according to the max function in equation (3) described above. That is, the processing in step S107 is skipped.

When the negative amount of the deviation amounts ΔXh and ΔXs is equal to or larger than the predetermined value (step S109: Yes), it may be difficult or impossible to generate the target path including the forward path Ra and finally reaching the target parking position Pt. In this case, the computation unit 303 ends target path generation processing with an error (step S110).

When the deviation amounts ΔXh and ΔXs are positive values (step S106: No), or when the negative amount of the deviation amounts ΔXh and ΔXs that are negative values is less than the predetermined value (step S109: No), the computation unit 303 generates the target path including the forward path Ra to which the preliminary path Rp is added and on which the start point is shifted by the deviation amounts ΔXh and ΔXs, or the forward path Ra on which the position of the start point of the default path Rs is maintained (step S108).

As described above, the target path generation processing by the towing assistance apparatus 30 in the embodiment is ended.

### Overview

The towing assistance apparatus assists towing of the tractor or the like for towing the trailer. In the backward parking assistance of the tractor, for example, the target path including the forward path for moving the tractor forward, the turning position for turning the tractor, and the backward path for moving the tractor backward is generated. However, in order to appropriately generate the target path including the plurality of paths according to various positional relationships between the tractor and the parking region at the start position of the backward parking assistance, complicated computation is required, which increases calculation cost and makes it difficult to generate the target path.

According to the towing assistance apparatus 30 in the embodiment, the computation unit 303 generates the target path including the forward path Ra and the backward path Rb of the tractor 10 based on the default stop position Ps and the default path Rs set in advance. In this way, by generating the forward path Ra based on the default path Rs set in advance, it is possible to easily generate a path regardless of the parking angle θ and the positional relationship between the tractor 10 and the target stop position Pa.

According to the towing assistance apparatus 30 in the embodiment, in a case where the total value of the deviation amount ΔXh in the front-rear direction of the tractor 10, which is the deviation amount between the target stop position Pa determined based on the parking region PR and the default stop position Ps, and the deviation amount ΔXs in the front-rear direction of the tractor 10, which is generated according to the parking angle θ when the tractor 10 is parked in the parking region PR, is a positive value, the computation unit 303 generates the forward path Ra on which the position of the start point of the default path Rs is shifted in the forward direction of the tractor 10 by the total value of the deviation amounts ΔXh and ΔXs.

Accordingly, it is possible to generate the forward path Ra according to the parking angle θ and the positional relationship between the tractor 10 and the target stop position Pa. Since the target path is generated in consideration of the deviation amount ΔXs due to the parking angle θ, for example, even when the parking angle θ is large, the target path including the turning can be compactly generated, and stable path generation can be performed.

According to the towing assistance apparatus 30 in the embodiment, when the total value of the deviation amounts ΔXh and ΔXs is a positive value, the computation unit 303 generates the forward path Ra by shifting the position of the start point of the default path Rs and adding the preliminary path Rp for moving the tractor 10 forward by the total value. In this way, the path can be easily generated by shifting the position of the start point Pc of the forward path Ra and adding the preliminary path Rp for moving the tractor 10 forward to the position of the start point Pc.

According to the towing assistance apparatus 30 in the embodiment, when the total value of the deviation amounts ΔXh and ΔXs is a negative value less than the predetermined amount, the computation unit 303 generates the forward path Ra on which the position of the start point of the default path Rs is maintained. In this way, under the predetermined condition as described above, the default path Rs can be directly reused as the forward path Ra, and the path can be easily generated.

### Modification

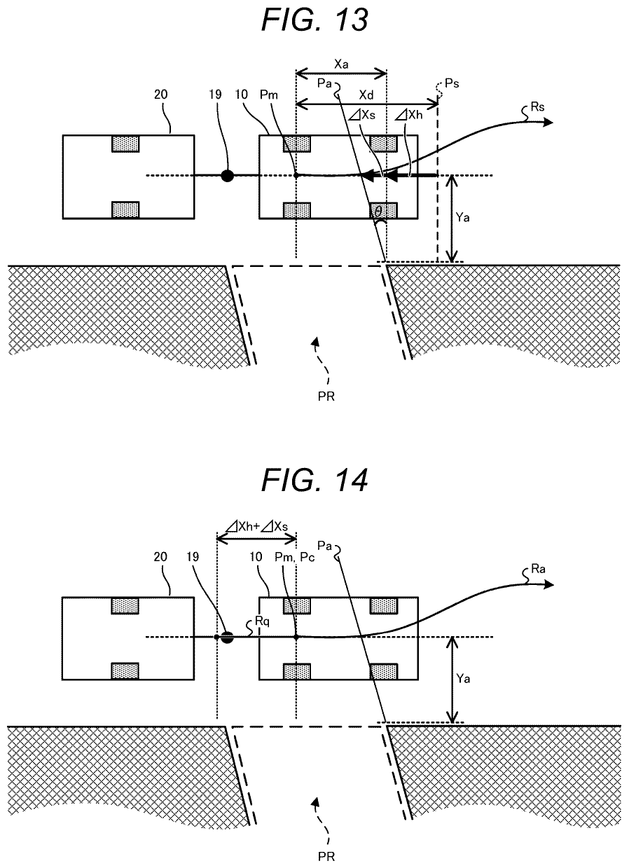

Next, a towing assistance apparatus according to a modification of the embodiment will be described with reference to FIGS. 13 to 15. The towing assistance apparatus in the modification is different from the above-described embodiment in that, when the deviation amounts ΔXh and ΔXs between the default stop position Ps and the target stop position Pa are negative values, these values are reflected in the target path generation.

FIGS. 13 and 14 show an example of an operation in which the towing assistance apparatus according to the modification of the embodiment generates a forward path in a target path. In the following description, configurations similar to those in the above-described embodiment are denoted by the same reference signs, and description thereof may be omitted.

In the example shown in FIG. 13, the deviation amounts ΔXh and ΔXs that are both negative values occur relative to the default stop position Ps set in advance.

That is, as shown in FIG. 13, the target stop position Pa of the parking region PR, which is a side portion of the parking region PR in front of the tractor 10, is located on the near side of the tractor 10 relative to the default stop position Ps. In this case, the distance Xa from the tractor position Pm to the target stop position Pa is a distance from the tractor position Pm to a position of a side portion at an entrance position in front of the tractor 10. Therefore, the deviation amount ΔXh, that is, a value of (Xa−Xd) is negative.

The parking region PR is inclined to the near side of the tractor 10, and the deviation amount ΔXs, that is, a value of Ya·tanθ is also negative.

As shown in FIG. 14, in the towing assistance apparatus in the modification, the computation unit 303 generates the forward path Ra by adding a preliminary path Rq based on the following equation (4) regardless of whether the total value of the deviation amounts ΔXh and ΔXs is positive or negative.

$$Distance of preliminary path Rq = Δ Xh + Δ Xs \qquad ( 4 )$$

That is, if the total value of the deviation amounts ΔXh and ΔXs is a positive value, the computation unit 303 shifts the start point Pc of the forward path Ra to the front of the tractor 10 by the total value, and adds the preliminary path Rq for moving the tractor 10 forward from the tractor position Pm to the start point Pc of the forward path Ra.

On the other hand, if the total value of the deviation amounts ΔXh and ΔXs is a negative value, the computation unit 303 adds the preliminary path Rq for moving the tractor 10 backward by the total value of the deviation amounts ΔXh and ΔXs from the start point Pc of the forward path Ra without shifting the start point Pc of the forward path Ra.

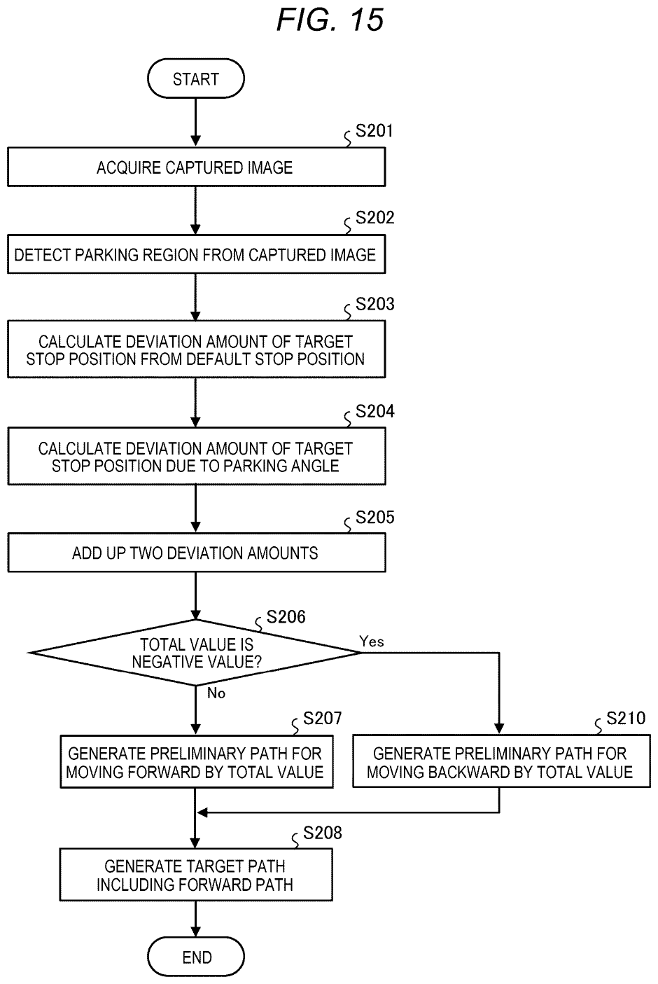

FIG. 15 is a flowchart showing an example of a procedure for generating a target path for backward parking by the towing assistance apparatus according to the modification of the embodiment.

As shown in FIG. 15, in the towing assistance apparatus in the modification, processing of steps S201 to S208 is performed similarly to the processing of steps S101 to S108 in FIG. 12 in the above-described embodiment.

Meanwhile, when the total value of the deviation amounts ΔXh and ΔXs is a negative value, the computation unit 303 generates the preliminary path Rq for moving the tractor 10 backward by the total value. The computation unit 303 also generates the target path including the preliminary path Rq (step S208).

As described above, the target path generation processing by the towing assistance apparatus in the modification is ended.

According to the towing assistance apparatus in the modification, when the total value of the deviation amounts ΔXh and ΔXs is a negative value, the computation unit 303 generates the preliminary path Rq for moving the tractor 10 backward by the total value from the position of the start point of the default path Rs. Accordingly, it is possible to generate a path more flexibly.

In the embodiment and the modification described above, when the backward parking assistance is started, the deviation amounts ΔXh and ΔXs of the target stop position Pa change depending on the position where the tractor 10 is positioned alongside the parking region PR. However, for example, the driver may be allowed to move the parking region PR detected by the detection unit 302 of the towing assistance apparatus 30 on the monitor apparatus 40 as desired, and the configurations of the embodiment and the modification described above can easily perform path generation following such an operation.

A towing assistance apparatus according to an embodiment is a towing assistance apparatus that assists backward parking of a towing vehicle towing a towed vehicle, the towing assistance apparatus including: a detection unit configured to detect a parking region having an entrance on a lateral side of the towing vehicle; and a computation unit configured to generate a target path including a forward path and a backward path of the towing vehicle based on a default stop position and a default path that are set in advance, in which the computation unit calculates a first deviation amount in a front-rear direction of the towing vehicle, which is a deviation amount between a target stop position determined based on the parking region and the default stop position, and a second deviation amount in the front-rear direction of the towing vehicle, which is generated according to a parking angle when the towing vehicle is parked in the parking region, and generates the forward path based on a total value of the first and second deviation amounts.

The towing assistance apparatus in the embodiment can easily generate a path regardless of a parking angle and a positional relationship between a towing vehicle and a target stop position.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A towing assistance apparatus that assists backward parking of a towing vehicle towing a towed vehicle, the towing assistance apparatus comprising:
a detection unit configured to detect a parking region having an entrance on a lateral side of the towing vehicle; and
a computation unit configured to generate a target path including a forward path and a backward path of the towing vehicle based on a default stop position and a default path that are set in advance, wherein
the computation unit
calculates a first deviation amount in a front-rear direction of the towing vehicle, which is a deviation amount between a target stop position determined based on the parking region and the default stop position, and a second deviation amount in the front-rear direction of the towing vehicle, which is generated according to a parking angle when the towing vehicle is parked in the parking region, and
generates the forward path based on a total value of the first and second deviation amounts.

2. The towing assistance apparatus according to claim 1, wherein
when the total value is a positive value, the computation unit generates the forward path by shifting a position of a start point of the default path and adding a preliminary path for moving the towing vehicle forward by the total value.

3. The towing assistance apparatus according to claim 1, wherein
when the total value is a negative value less than a predetermined amount, the computation unit generates the forward path on which a position of a start point of the default path is maintained.

4. The towing assistance apparatus according to claim 1, wherein
when the total value is a negative value, the computation unit generates a preliminary path for moving the towing vehicle backward by the total value from a position of a start point of the default path.
